(19) United States
(12) Patent Application Publication
(10) Pub. No.: US 2007/0070907 A1
(43) Pub. Date: Mar. 29, 2007

(54) Method and apparatus to implement a very efficient random early detection algorithm in the forwarding path

(76) Inventors: Alok Kumar, Santa Clara, CA (US); Uday Naik, Fremont, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/238,474

(22) Filed: Sep. 29, 2005

(51) Int. Cl. H04J 1/16; H04L 12/56

(52) U.S. Cl. 370/235; 370/412

(57) ABSTRACT

A method and apparatus for implementing a very efficient random early detection algorithm in the forwarding path of a network device. Under one embodiment of the method flows are associated with corresponding Weighted Random Early Detection (WRED) drop profile parameters, and a flow queue is allocated to each of multiple flows. Estimated drop probability values are repeatedly generated for the flow queues based on existing flow queue state data in combination with WRED drop profile parameters. In parallel, various packet forwarding operations are performed, including packet classification, which assigns a packet to a flow queue for enqueing. In conjunction with this, a determination is made to whether to enqueue the packet in the flow queue or drop it by comparing the estimated drop probability value for the flow queue with a random number that is generated in the forwarding path.

### FIELD OF THE INVENTION

The field of invention relates generally to networking equipment and, more specifically but not exclusively relates to techniques for detecting packet flow congestion using an efficient random early detection algorithm that may be implemented in the forwarding path of a network device and/or network processor.

### BACKGROUND INFORMATION

Network devices, such as switches and routers, are designed to forward network traffic, in the form of packets, at high line rates. One of the most important considerations for handling network traffic is packet throughput. To accomplish this, special-purpose processors known as network processors have been developed to efficiently process very large numbers of packets per second. In order to process a packet, the network processor (and/or network equipment employing the network processor) extracts data from the packet header indicating the destination of the packet, class of service, etc., store the payload data in memory, perform packet classification and queuing operations, determine the next hop for the packet, select an appropriate network port via which to forward the packet, etc. These operations are generally referred to as “packet processing” or “packet forwarding” operations.

Many modern network devices support various levels of service for subscribing customers. For example, certain types of packet “flows” are time-sensitive (e.g., video and voice over IP), while other types are data-sensitive (e.g., typical TCP data transmissions). Under such network devices, received packets are classified into flows based on various packet attributes (e.g., source and destination addresses and ports, protocols, and/or packet content), and enqueued into corresponding queues for subsequent transmission to a next hop along the transfer path to the destined end device (e.g., client or server). Depending on the policies applicable to a given queue and/or associated Quality of Service (QoS) level, various traffic policing schemes are employed to account for network congestion.

One aspect of the policing schemes relates to how to handle queue overflow. Typically, fixed-size queues are allocated for new or existing service flows, although variable-size queues may also be employed. As new packets are received, they are classified to a flow and added to an associated queue. Meanwhile, under a substantially parallel operation, packets in the flow queues are dispatched for outbound transmission (dequeued) on an ongoing basis, with the transmission dispatch rate depending on network availability. Further consider that both the packet receive and dispatch rates are dynamic in nature. As a result, the number of packets in a given flow queue fluctuates over time, depending on network traffic conditions.

In further detail, buffer managers or the like are typically employed for managing the length of the flow queues by selectively dropping packets to prevent queue overflow. Under connection-oriented transmissions, dropping packets indicate to the end devices (i.e., the source and destination devices) that the network is congested. In response to detecting such dropped packets, protocols such as TCP typically back off and reduce the rate at which they transmit packets on a corresponding connection. At the same time, packet-oriented traffic is typically bursty, which means that a device may often see periods of transient congestion followed by periods of little or no traffic. Therefore, the dual goals of the buffer manager are to allow temporary bursts and fluctuations in the packet arrival rate, while actively avoiding sustained congestion by providing an early indication to the end devices that such congestion is present.

The simplest scheme for buffer management is called “tail drop,” under which each queue is assigned a maximum threshold. If a packet arrives on a queue that has reached the maximum threshold, the buffer manager drops the packet rather than appending it to the end (i.e., tail) of the queue. Even though this scheme is very easy to implement, it is a reactive measure since it waits until a queue is full prior to dropping any packets. Therefore, the end devices do not get an early indication of network congestion. This, coupled with the bursty nature of the traffic, means that the network device may drop a large chunk of packets when a queue reaches its maximum threshold.

Other more complex detection algorithms have been developed to address queue management. These include the Random Early Detection (RED) algorithm, and Weighted Random Early Detection (WRED) algorithm. Although these algorithms are substantial improvements over the simplistic tail drop scheme, they require significant computation overhead, and may be impractical to implement in the forwarding path while maintaining today's and future high line-rate speeds.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein like reference numerals refer to like parts throughout the various views unless otherwise specified:

FIG. 1 is a diagram illustrating the parameters of an RED drop profile;

FIG. 2a illustrates an exemplary set of WRED drop profiles having a common maximum probability;

FIG. 2b illustrates an exemplary set of WRED drop profiles having different maximum probabilities;

FIG. 3 is a diagram of a flow queue in which packets assigned to different WRED colors are stored;

FIG. 4 is a schematic diagram of a WRED implementation using different WRED drop profiles for different service classes;

FIG. 5 is a schematic diagram illustrating a technique for processing multiple functions via multiple compute engines using a context pipeline;

FIG. 6 is a schematic diagram of an exemplary execution environment in which embodiments of the invention may be implemented;

FIG. 7 is a flowchart illustrating operations performed in conjunction with packet forwarding to determine if packets should be dropped;

FIG. 8 is a flowchart illustrating operations for performing queue state recalculation;

FIG. 9 illustrates an exemplary WRED data structure; and

FIG. 10 is a pseudo code listing illustrating adding WRED to a scheduler that tracks queue size, and handles enqueue and dequeue operations in conjunction with a queue manager.

### DETAILED DESCRIPTION

Embodiments of methods and apparatus for implementing very efficient random early detection algorithms in forwarding (fast) path of network processors are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In accordance with aspects of the embodiment described herein, enhancements to the RED and WRED algorithms are disclosed that provide substantial improvements in terms of efficiency and process latency, thus enabling these algorithms to be implemented in the forwarding path of a network device. In order to better understand operation of these embodiments, a discussion of the conventional RED, and WRED schemes are first presented. Following this, details of implementations of the enhanced algorithms are discussed.

RED as described in Floyd, S, and Jacobson, V, “Random Early Detection Gateways for Congestion Avoidance,” IEEE/ACM Transactions on Networking, V.1 N.4, August 1993, p. 397-413 (hereinafter [RED93]) is an algorithm that marks packets (e.g., to be dropped) based on a probability that increases with the average length of the queue. (It is noted that under RED93, packets are termed “marked,” wherein the marking may be either employed to return information back to the sender identifying congestion or to mark the packets to be dropped. However, under most implementations, the packets are simply dropped rather than marked.) The algorithm calculates the average queue size using a low-pass filter with an exponential weighted moving average. Since measurement of the average queue size is time-averaged rather than an instantaneous length, the algorithm is able to smooth out temporary bursts, while still responding to sustained congestion.

In further detail, the average queue size avg_len is determined by implementing a low-pass EWMA (Exponential Weighted Moving Average) filter using the following equation:
avg_len=avg_len+weight*(current_len−avg_len) (1)
where,
avg_len is the average length of the queue
current_len is the current length of the queue and
weight is the filter gain

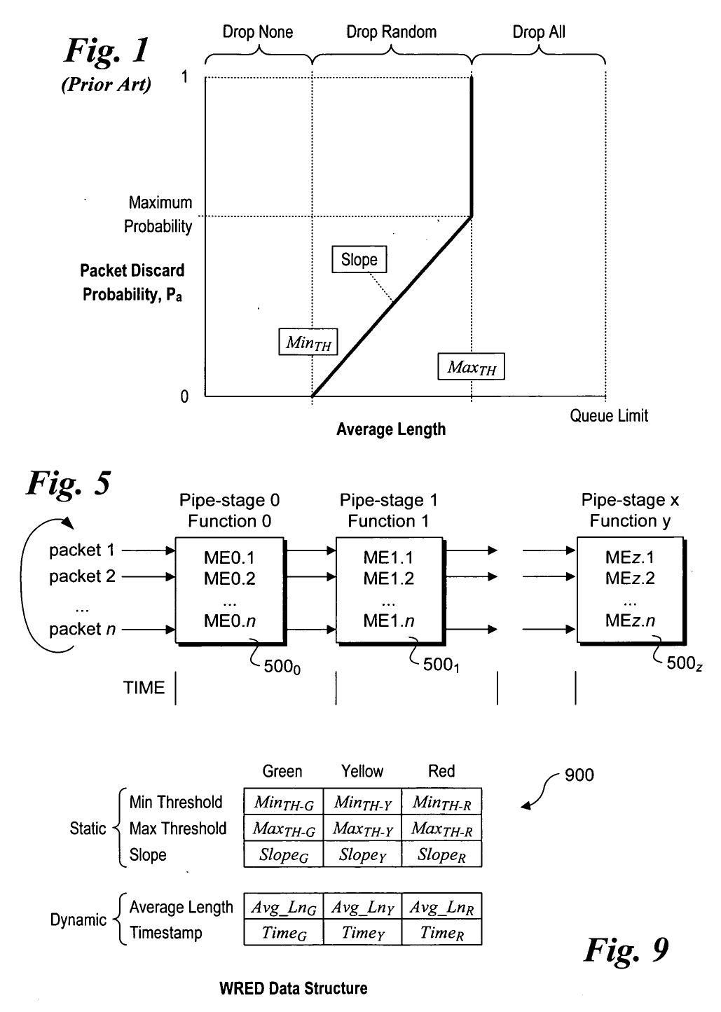

Once the average queue size is determined, it is compared with two thresholds, a minimum threshold minₜₕ, and a maximum threshold maxₜₕ. When the average queue size is less than the minimum threshold, no packets are dropped. When the average queues size exceeds the maximum threshold, all arriving packets are dropped. When the average queue size is between the minimum and maximum thresholds, each arriving packet is marked with a probability pₐ, where pₐ is a function of the average queue size avg_len. This is schematically illustrated in FIG. 1 and discussed in further detail below.

As seen from above, the RED algorithm actually employs two separate algorithms. The first algorithm for computing the average queue size determines the degree of burstiness that will be allowed in a given connection (i.e., flow) queue, which is a function of the weight parameter (and thus the filter gain). Thus, the choice of the filter gain weight determines how quickly the average queue size changes with respect to the instantaneous queue size (in view of an even packet arrival rate for the connection). If the weight is too large, then the filter will not be able to absorb transient bursts, while a very small value could mean that the algorithm does not detect incipient congestion early enough. [RED 93] recommends a value between 0.002 and 0.042 for a throughput of 1.5 Mbps.

The second algorithm used for calculating the packet-marking probability determines how frequently the network device (implementing RED) marks packets, given the current level of congestion. Each time that a packet is marked, the probability that a packet is marked from a particular connection is roughly proportional to that connection's share of the bandwidth at the network device. The goal for the network device is to mark packets at fairly evenly-spaced intervals, in order to avoid biases and to avoid global synchronization, and to mark packets sufficiently frequently to control the average queue size.

As show in FIG. 1, the packet drop probability is based on the minimum threshold minₜₕ, the maximum threshold maxₜₕ, and a mark probability denominator. When the average queue size is above the minimum threshold, RED starts marking (or dropping) packets. The rate of packet drop increases linearly as the average queue size increases until the average queue size reaches the maximum threshold. The mark probability denominator is the fraction of packets dropped when the average queue depth is at the maximum threshold. For example, if the denominator is 512, one out of every 512 packets is dropped when the average queue is at the maximum threshold. When the average queue size is above the maximum threshold, all packets are dropped.

When a queue goes idle, [RED93] specifies an equation that attempts to estimate the number of packets that could have arrived during the idle period:
m=(current_timestamp−last_idle_timestamp)/average_service_time
avg_len=avg_len*(1−weight)^{m} (2)
where,
last_idle_timestamp is the timestamp value when the queue length became zero; and
average_service_time is the typical transmission time for a small packet.

WRED (Weighted RED) is an extension of RED where different packets can have different drop probabilities based on corresponding QoS parameters. For example, under a typical WRED implementation, each packet is assigned a corresponding color; namely Green, Yellow, and Red. Packets that are committed for transmission are assigned to Green. Packets that conform but are yet to be committed are assigned to Yellow. Exceeded packets are assigned to Red. When the queue fills above the exceeded threshold, all packets are dropped.

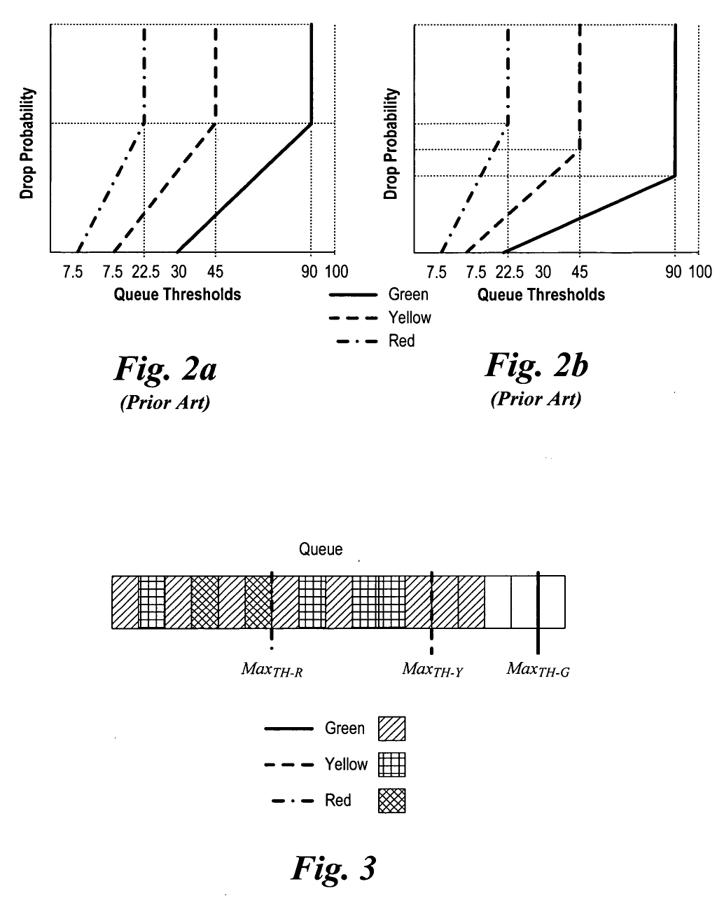

Drop profiles based on exemplary sets of Green, Yellow, and Red WRED thresholds and weight parameters are illustrated in FIG. 2a and FIG. 2b. The parameters in FIG. 2a correspond to a color-blind RED drop profile with color-sensitive queue profiles. In this instance, the maximum probability for each of the three colors is the same, while the values for the minimum threshold, maximum threshold, and weight vary for each color. Under the exemplary parameters, the drop and queue profiles specify that:
1) When the average queue length is between 30% full (30 KB) and 90% full (90 KB), randomly drop up to 5% of the packets. In this case, the maximum queue length is 100 KB for green packets, 50 KB for yellow packets, and 25 KB for red packets. Therefore, the system randomly drops:
   a) Red packets when the average queue length is between 7.5 KB and 22.5 KB;
   b) Yellow packets when the average queue length is between 15 KB and 45 KB; and
   c) Green packets when the average queue length is between 30 KB and 90 KB.
2) When the average queue length is greater than 90% of the maximum queue length, drop all packets. Therefore, the system drops:
   a) Red packets when the average queue length is greater than 22.5 KB;
   b) Yellow packets when the average queue length is greater than 45 KB; and
   c) Green packets when the average queue length is greater than 90 KB.

A “snapshot” illustrating the current condition of an exemplary queue are shown in FIG. 3. Note that under this scheme, packets assigned to different colors are queued into the same queue. In other embodiments, packets assigned to different colors will likewise be stored in separate queues.

The exemplary parameters shown in FIG. 2b correspond to a scheme under which different treatment is applied to the colored packets. This profile yields progressively more aggressive drop treatment for each color. Exceeded traffic (RED) is dropped over a wider range and with greater maximum drop probability than conformed or committed traffic. Conformed traffic (Yellow) is dropped over a wider range and with greater maximum drop probability than committed traffic (Green).

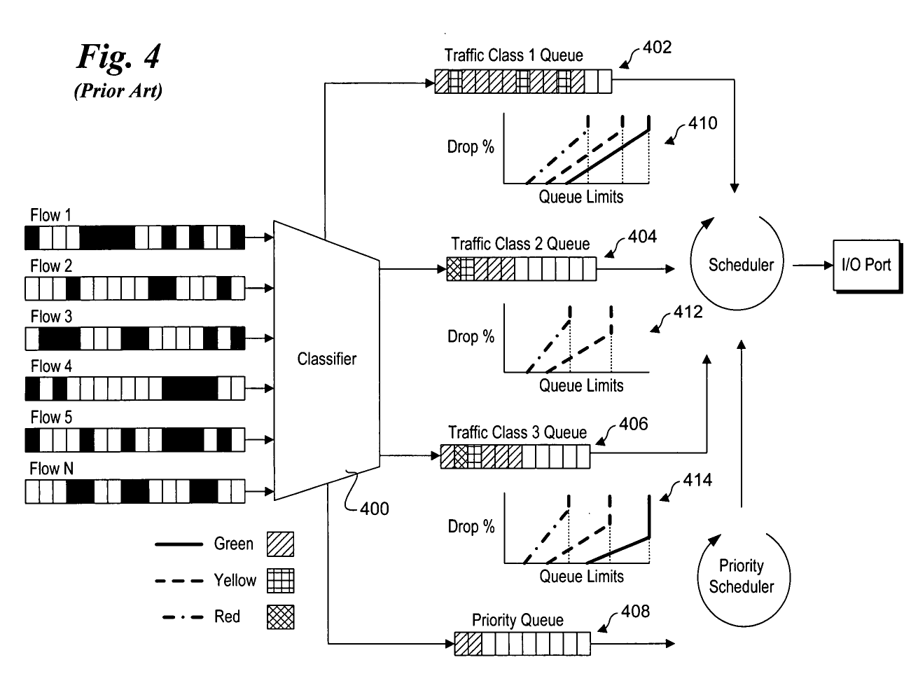

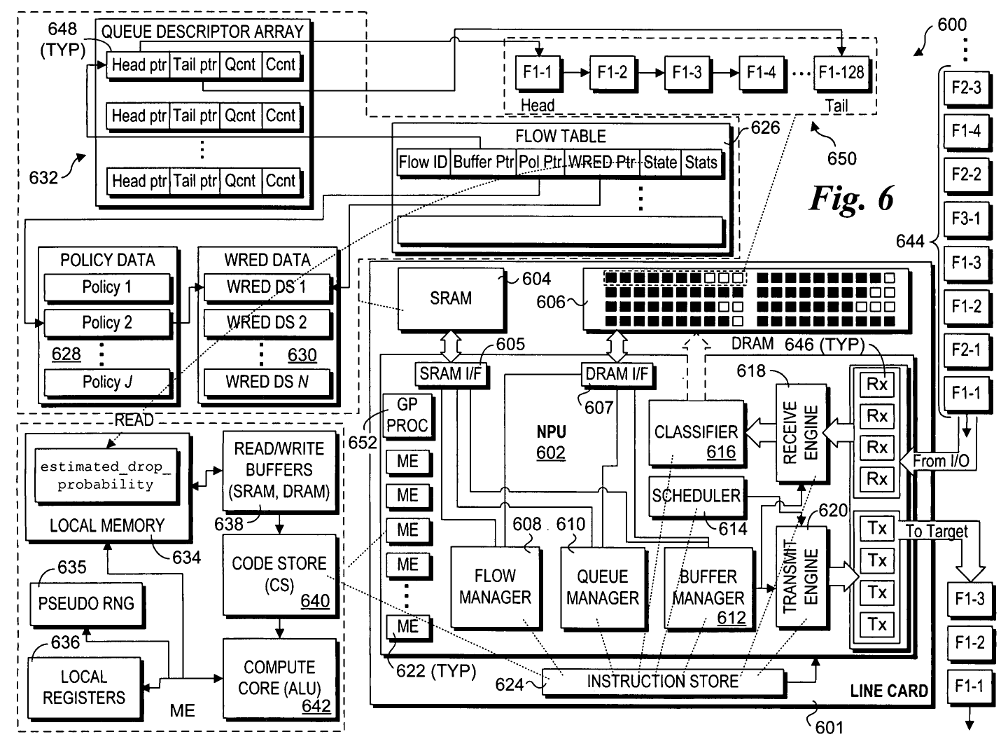

It is also possible to employ different drop behavior for different classes of traffic (i.e., different service classes). This enables one to assign less aggressive drop profiles to higher-priority queues (e.g., queues associated with higher QoS) and more aggressive drop profiles to lower-priority queues (lower Qos queues). FIG. 4 shows an exemplary implementation under which incoming packets from flows 1-N are classified by a classifier 400 into one of four traffic classes (1-3 and priority). As depicted, each of the traffic classes includes a respective queue 402, 404, 406, and 408. Additionally, each of traffic classes 1-3 includes an associated respective drop profile 410, 412, and 414. Meanwhile, there is no drop profile for the priority traffic class, since all of the packets assigned to this queue will be forwarded and not dropped.

The implementation depicted in FIG. 4 also illustrates different drop profiles for the different traffic classes 1-3. Additionally, as depicted by drop profile 412, there need not be a set of drop profile thresholds for each color; in this instance, all packets assigned to Green will be forwarded.

One of the key problems with the original algorithm defined in [RED93] was that it was targeted toward the low-speed T1/E1 links common at the time, and it does not scale very well to higher data rates. In Jacobson et al., “Notes on using RED for Queue Management and Congestion Avoidance,” viewgraphs, talk at NANOG 13, June 1998 (hereinafter [RED99]) Jacobson et al. describe a design that significantly optimizes the implementation of WRED in the forwarding path. A key difference is that unlike [RED93], the design does not compute the average queue size at packet arrival time. Instead, the algorithm samples the size of the queue and approximates the persistent queue size only at periodic intervals. The authors of [RED99] recommend a sampling interval of up to 100 times a second irrespective of the link speed, which allows the implementation to scale to very high data rates. For the packet drop calculation, [RED99] recommends including the following code in the forwarding path.

```
drop_count = drop_count − 1;
if (drop_count == 0)
{
  drop the packet
  drop_count = estimated_drop_count
}
```

### ALGORITHM 1

The [RED99] algorithm calculates estimated_drop_count during the averaging of the queue size.

While the [RED99] algorithm variation is a lot more efficient than the one proposed in [RED93], it still implies a critical section for the code that updates the drop_count variable. That is, this portion of code is a mutually exclusive section that must be performed on all packets. This critical section requires the current drop count to be retrieved (read from memory), an arithmetic comparison operation be performed, an entire estimated_drop_count algorithm be performed to calculate the new drop_count variable, and then storage of the updated drop_count variable. Under one state of the art implementation, the critical section requires 55 processor cycles. This represents a significant portion of the forwarding path latency budget.

To better understand the problem with the increased latency resulting from the critical section, one needs to consider the parallelism employed by some modern network processors and/or network device forwarding path implementations. Under the foregoing scheme, it is still necessary for the drop_count calculation be performed on each packet. This increases the overall packet processing latency, thus reducing packet throughput. Under a parallel pipelined packet processing scheme, some packet-processing may not commence until other packet-processing operations have been completed. Accordingly, upstream latencies cause delays to the entire forwarding path.

Modern network processors, such as Intel® Corporation's (Santa Clara, Calif.) IXP2XXX family of network processor units (NPUs), employ multiple multi-threaded processing elements (e.g., compute engines referred to as microengines (MEs) under Intel's terminology) to facilitate line-rate packet processing operations in the forwarding path (also commonly referred to as the forwarding plane, data plane or fast path). In order to process a packet, the network processor (and/or network equipment employing the network processor) needs to extract data from the packet header indicating the destination of the packet, class of service, etc., store the payload data in memory, perform packet classification and queuing operations, determine the next hop for the packet, select an appropriate network port via which to forward the packet, dequeuing etc.

Some of the operations on packets are well-defined, with minimal interface to other functions or strict order implementation. Examples include update-of-packet-state information, such as the current address of packet data in a DRAM buffer for sequential segments of a packet, updating linked-list pointers while enqueuing/dequeuing for transmit, and policing or marking packets of a connection flow. In these cases, the operations can be performed within the predefined cycle-stage budget. In contrast, difficulties may arise in keeping operations on successive packets in strict order and at the same time achieving cycle budget across many stages. A block of code performing this type of functionality is called a context pipe stage.

In a context pipeline, different functions are performed on different microengines (MEs) as time progresses, and the packet context is passed between the functions or MEs, as shown in FIG. 5. Under the illustrated configuration, z MEs 500_{0-z} are used for packet processing operations, with each ME running n threads. Each ME constitutes a context pipe stage corresponding to a respective function executed by that ME. Cascading two or more context pipe stages constitutes a context pipeline. The name context pipeline is derived from the observation that it is the context that moves through the pipeline.

Under a context pipeline, each thread in an ME is assigned a packet, and each thread performs the same function but on different packets. As packets arrive, they are assigned to the ME threads in strict order. For example, there are eight threads typically assigned in an Intel IXP2800® ME context pipe stage. Each of the eight packets assigned to the eight threads must complete its first pipe stage within the arrival rate of all eight packets. Under the nomenclature illustrated in FIG. 5, MEi,j, i corresponds to the ith ME number, while j corresponds to the jth thread running on the ith ME.

A more advanced context pipelining technique employs interleaved phased piping. This technique interleaves multiple packets on the same thread, spaced eight packets apart. An example would be ME0.1 completing pipe-stage 0 work on packet 1, while starting pipe-stage 0 work on packet 9. Similarly, ME0.2 would be working on packet 2 and 10. In effect, 16 packets would be processed in a pipe stage at one time. Pipe-stage 0 must still advance every 8-packet arrival rates. The advantage of interleaving is that memory latency is covered by a complete 8-packet arrival rate.

According to aspects of the embodiments now described, enhancements to WRED algorithms and associated queue management mechanisms are implemented using NPUs that employ multiple multi-threaded processing elements. The embodiments facilitate fast-path packet forwarding using the general principles employed by conventional WRED implementations, but greatly reduce the amount of processing operations that need to be performed in the forwarding path related to updating flow queue state and determining an associated drop probability for each packet. This allows implementations of WRED techniques to be employed in the forwarding path while supporting very high line rates, such as OC-192 and higher.

It was recognized by the inventors that RED and WRED schemes could be modified using the following algorithm on an NPU that employs multiple compute engines and/or other processing elements to determine whether or not to drop a packet in the context of parallel packet processing techniques:

random_number = get_random( );
if (random_number < estimated_drop_probability)
drop the packet;

### ALGORITHM 2

It was further recognized that since the microengine architecture of the Intel® IXP2XXX NPUs include a built-in pseudo-random number generator, the number of processing cycles required to perform the foregoing algorithm would be greatly reduced. This modification eliminates the critical section completely, since the packet-forwarding path only reads the estimated_drop_probability value and does not modify it. The variation also saves SRAM bandwidth associated with reading and writing the drop_count in [RED99]. Using the pseudo-random number generator on the microengines, the above calculation only requires four instructions per packet in the microengine fast path. Thus, this scheme is very suitable for parallel processing architectures, as it removes restrictions on parallelization of WRED implementations by completely eliminating the aforementioned critical section.

An exemplary execution environment 600 for implementing embodiments of the enhanced WRED algorithm is illustrated in FIG. 6. The execution environment pertains to a network line card 601 including an NPU 602 coupled to an SRAM store (SRAM) 604 via an SRAM interface (I/F) 605, and coupled to a DRAM store (DRAM) 606 via a DRAM interface 607. Selected modules (also referred to as “blocks”) are also depicted for NPU 602, including a flow manager 608, a queue manager 610, a buffer manager 612, a scheduler 614, a classifier 616, a receive engine 618, and a transmit engine 620. In the manner described above, the operations associated with each of these modules are facilitates by corresponding instruction threads executing on MEs 622. In one embodiment, the instruction threads are initially stored (prior to code store load) in an instruction store 624 on network line card 600 comprising a non-volatile storage device, such as flash memory or a mass storage device or the like.

As illustrated in FIG. 6, various data structures and tables are stored in SRAM 604. These include a flow table 626, a policy data structure table 628, WRED data structure table 630, and a queue descriptor array 632. Also, packet metadata (not shown for clarity) is typically stored in SRAM as well. In some embodiments, respective portions of a flow table may be split between SRAM 604 and DRAM 606; for simplicity, all of the flow table 626 data is depicted as being stored in SRAM 604 in FIG. 6.

Typically, information that is frequently accessed for packet processing (e.g., flow table entries, queue descriptors, packet metadata, etc.) will be stored in SRAM, while bulk packet data (either entire packets or packet payloads) will be stored in DRAM, with the latter having higher access latencies but costing significantly less. Accordingly, under a typical implementation, the memory space available in the DRAM store is much larger than that provided by the SRAM store.

As shown in the lower left-hand corner of FIG. 6, each ME 7622 includes a local memory 634, a pseudo random number generator (RNG) 635, local registers 636, separate SRAM and DRAM read and write buffers 638 (depicted as a single block for convenience), a code store 640, and a compute core (e.g., Arithmetic Logic Unit (ALU)) 642. In general, information may be passed to and from an ME via the SRAM and DRAM write and read buffers, respectively. In addition, in one embodiment a next neighbor buffer (not shown) is provided that enables data to be efficiently passed between ME's that are configured in a chain or cluster. It is noted that each ME is operatively-coupled to various functional units and interfaces on NPU 602 via appropriate sets of address and data buses referred to as an interconnect; this interconnect is not illustrated in FIG. 6 for clarity.

As describe below, each WRED data structure will provide information for effectuating a corresponding drop profile in a manner analogous to that described above for the various WRED implementations in FIGS. 2a, 2b, and 4. The various WRED data structures will typically be stored in WRED data structure table 630, as illustrated in FIG. 6. However, there may be instances in which selected WRED data structures are stored in selected code stores that are configured to store both instruction code and data.

In addition to storing the WRED data structures, associated lookup data is likewise stored in SRAM 604. In the embodiment illustrated in FIG. 6, the lookup data is stored as pointers associated with a corresponding policy in the policy data structure table 628. The WRED data structure lookup data is used, in part, to build flow table entries in the manner described below. Other schemes may also be employed.

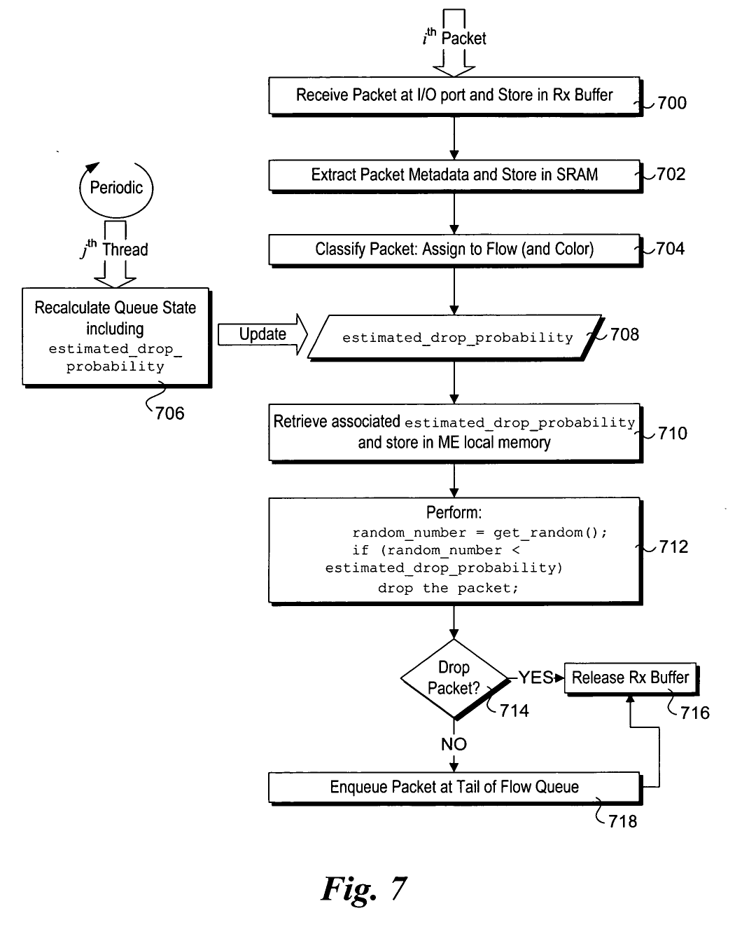

An overview of operations performed during run-time packet forwarding is illustrated in FIG. 7. The operations are performed in response to receiving an i^{th} packet at an input/output (I/O) port of line card 601, or received at another I/O port of another line card in the network device (e.g., an ingress card) and forwarded to line card 601. In connection with execution environment 600, the following operations are performed via execution of one or more threads on one or more MEs 622.

With reference to execution environment 600 and a block 700 in FIG. 7, as input packets 644 are received at line card 601, they are processed by receive engine 618, which temporarily stores them in receive (Rx) buffers 646 in association with ongoing context pipeline packet processing operations. In a block 702, the packet header data is extracted, and corresponding packet metadata is stored in SRAM 604. In a block 704, the packets are classified to assign the packet to a flow (and optional color for color-based WRED implementations) using one or more well-known classification schemes, such as, but not limited to 5-tuple classification. In some instances, the packet classification may also employ deep packet inspection, wherein the packet payload is searched for predefined strings and the like that identify what type of data the packet contains (e.g., video frames). In general, the packet will be assigned to an existing or new flow. For the purpose of the following discussion it is presumed that the packet is assigned to an existing flow.

By way of example, a typical 5-tuple flow classification is performed in the flowing manner. First, the 5-tuple data for the packet (source and destination IP address, source and destination ports, and protocol—also referred to as the 5-tuple signature) are extracted from the packet header. A set of classification rules are stored in an Access Control List (ACL), which will typically be stored in either SRAM or DRAM or both (more frequent ACL entries may be “cached” in SRAM, for example). Each ACL entry contains a set of values associated with each of the 5 tuple fields, with each value either being a single value, a range, or a wildcard. Based on an associated ACL lookup scheme, one or more ACL entries containing values matching the 5-tuple signature will be identified. Typically, this will be reduced to a highest-priority matching rule set in the case of multiple matches. Meanwhile, each rule set is associated with a corresponding flow or connection (via a Flow Identifier (ID) or connection ID). Thus, the ACL lookup matches the packet to a corresponding flow based on the packet's 5-tuple signature, which also defines the connection parameters for the flow.

Each flow has a corresponding entry in flow table 626. Management and creation of the flow entries is facilitated by flow manager 608 via execution of one or more threads on MEs 622. In turn, each flow has an associated flow queue (buffer) that is stored in DRAM 606. To support queue management operations, queue manager 610 and/or flow manager 608 maintains queue descriptor array 632, which contains multiple FIFO (first-in, first-out) queue descriptors 648. (In some implementations, the queue descriptors are stored in the on-chip SRAM interface 605 for faster access and loaded from and unloaded to queue descriptors stored in external SRAM 604.)

Each flow is associated with one or more (if chained) queue descriptors, with each queue descriptor including a Head pointer (Ptr), a Tail pointer, a Queue count (Qcnt) of the number of entries currently in the FIFO, and a Cell count (Cnt), as well as optional additional fields such as mode and queue status (both not shown for simplicity). Each queue descriptor is associated with a corresponding buffer segment to be transferred, wherein the Head pointer points to the memory location (i.e., address) in DRAM 606 of the first (head) cell in the segment and the Tail pointer points to the memory location of the last (tail) cell in the segment, with the cells in between being stored at sequential memory addresses, as depicted in a flow queue 650. Depending on the implementation, queue descriptors may also be chained via appropriate linked-list techniques or the like, such that a given flow queue may be stored in DRAM 606 as a set of disjoint segments.

Packet streams are received from various network nodes in an asynchronous manner, based on flow policies and other criteria, as well as less predictable network operations. As a result, on a sequential basis packets from different flows may be received in an intermixed manner, as illustrated by a stream of input packets 644 depicted toward the right-hand side of FIG. 6. For example, each of input packets 644 is labeled with F#-#, wherein the F# identifies the flow, and the -# identifies the sequential packet for a given flow. As will be understood, packets do not contain information specifically identifying the flow to which they are designed, but rather such information is determined during flow classification. However, the packet sequence data is provided in applicable packet headers, such as TCP headers (e.g., TCP packet sequence #). In FIG. 6, flow queue 648 is depicted to contain the first 128 packets in a Flow #1.

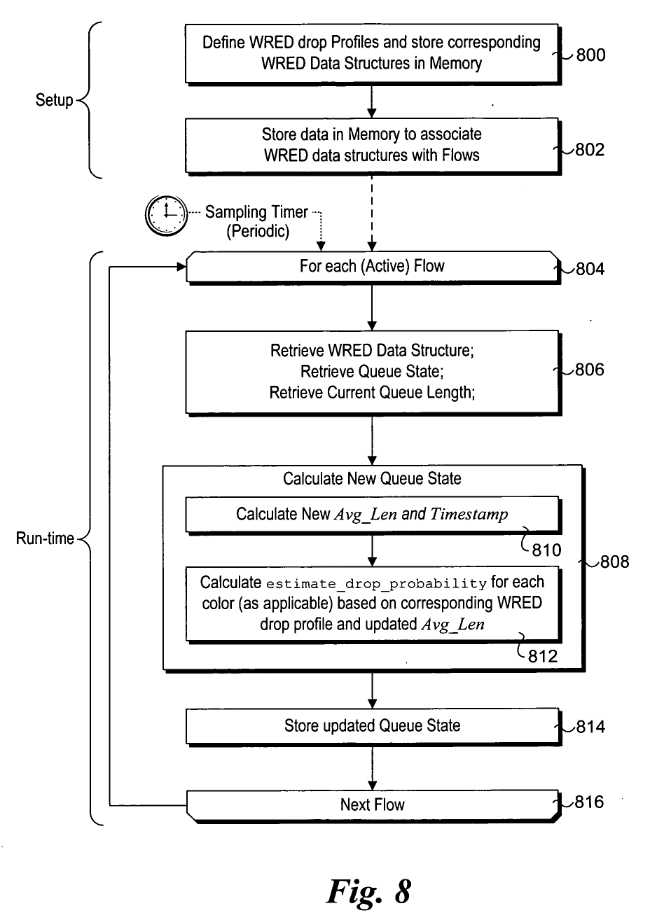

During on-going packet-processing operations, parallel operations are performed on a periodic basis in a substantially asynchronous manner. These operations include periodically (i.e., repeatedly) recalculating the queue state information for each flow queue in the manner discussed below with reference to FIGS. 8 and 9, as depicted by a block 706. Included in the operations is an update of the estimated_drop_probability value for each flow queue, as depicted by data 708. Thus, the estimated_drop_probability value for each flow queue is updated using a parallel operation that is performed independent of the packet-forwarding operations performed on a given packet.

Continuing at a block 710, in association with the ongoing packet-processing operation context, the current estimated_drop_probability value for the flow queue is retrieved, (i.e., read from SRAM 604) by the microengine running the current thread in the pipeline and stored in that ME's local memory 634, as schematically depicted in FIG. 6. The ME then performs algorithm 2 (above) in a block 712 to determine whether or not to drop the packet. During this operation, the ME issues an instruction to its pseudo random number generator to generate the random number used in the inequality,
random_number<estimated_drop_probability.

The result of the evaluation of the foregoing inequality is depicted by a decision block 714. If the inequality is True, the packet is dropped. Accordingly, this is simply accomplished in a block 716 by releasing the Rx buffer in which the packet is temporarily being store. If the packet is to be forwarded, it is added to the tail of the flow queue for the flow to which it is classified in a block 718 by copying the packet from the Rx buffer into an appropriate storage location in DRAM 606 (as identified by the Tail pointer for the associated queue descriptor), the Tail pointer is incremented by 1, and then the Rx buffer is released in a block 718.

With reference to FIGS. 8 and 9, operations corresponding to recalculating the queue state and updating the estimated_drop_probability value corresponding to block 706 proceed as follows. The first two operations depicted in blocks 800 and 802 correspond to setup (i.e., initialization) operations that are performed prior to the remaining run-time operations depicted in FIG. 8. In block 800, the WRED drop profiles are defined for the various implementation requirements, and corresponding WRED data structures are generated and stored in memory. In general, the WRED drop profiles for a given implementation may correspond to those shown in FIG. 2a, 2b or 4, or a combination of these. In addition, other types of drop profile definitions may be employed.

An exemplary WRED data structure 900 is shown in FIG. 9. In the illustrated embodiment, the WRED data structure includes a static portion and a dynamic portion. The static portion includes WRED drop profile data that is pre-defined and loaded into memory during an initialization operation or the like. The dynamic portion corresponds to data that is periodically updated. It is noted that under some embodiments, the static data may also be updated during ongoing network device operations without having to take the network device offline.

The exemplary WRED data illustrated in FIG. 9 includes minimum and maximum thresholds and slopes for each of three colors (Green, Yellow and Red). Optionally, maximum probability values could be included in place of the slopes; however, the probability calculations will employ the slopes that would be derived therefrom, so it is more efficient to simply store the slope data rather than the maximum probability for each drop profile.

In general, a WRED data structure will be generated for each service class. However, this isn't a strict requirement, as different service classes may share the same WRED data structure. In addition, more than three colors may be implemented in a similar fashion to that illustrated by the Green, Yellow, and Red implementations discussed herein. Furthermore, as discussed above with reference to FIG. 4, a given set of drop profiles may include less than all three colors.

Returning to FIG. 8, in a block 802 data is stored in memory to associate the WRED data structures with flows. In one embodiment illustrated in FIG. 6, this is accomplished using pointers and flow table entries in the following manner. Each flow is typically associated with some sort of policing policy, based on various service flow attributes, such as Qos for example. At the same time, multiple flows may be associated with a common policy.

In view of the foregoing, sets of policy data (wherein each set defines associated policies) are stored in SRAM 604 as policy data 628. At the same time, the various WRED data structures defined in block 800 are stored as WRED data structures 630 in SRAM 604. The policy data and WRED data structures are associated using a pointer included in each policy data entry. These associations are defined during the setup operations of blocks 800 and 802.

Following the setup operations, the run-time operations illustrated in FIG. 8 are performed periodically on a substantially continuous basis. As depicted by start and end loop blocks 804 and 816, the following loop operations are performed for each active flow. In general, the operations for a given flow are performed using a corresponding time-sampling period. In one embodiment, the means for effecting the time-sampling period is to use the timestamp mechanism described below.

In a block 806, various information associated with the flow is retrieved from SRAM 604 using a data read operation. This information includes the applicable WRED data structure, the flow queue state, and the current queue length. In the embodiment illustrated in FIG. 6, each flow table entry includes the following fields: A flow ID, a buffer pointer, a policy pointer, a WRED pointer, a state field, and an optional statistics field. It is noted that other fields may also be employed.

The flow ID identifies the flow (optionally a connection ID may be employed), and enables an existing flow entry to be readily located in the flow table. The buffer pointer points to the address of the (first) corresponding queue descriptor 648 in queue descriptor array 632. The policy pointer points to the applicable policy data in policy data 628. As discussed above, each policy data entry includes a pointer to a corresponding WRED data structure. (It is noted that the policy data may include other parameters that are employed for purposes outside the scope of the present specification.) Accordingly, when a new flow table entry is created, the applicable WRED data structure is identified via the policy pointer indirection, and a corresponding WRED pointer is stored in the entry.

In general, the flow queue state information may be stored inline with the flow table entry, or the state field may contain a pointer to where the actual state information is stored. In the embodiment illustrated in FIG. 9, a portion of the state information applicable to the state information update process of FIG. 8 is stored in the dynamic portion of WRED data structure 900. Thus, the queue state information may be retrieved from the associated flow table entry, the WRED data structure identified by the flow table entry, a combination of the two, or even at another location identified by a queue state pointer.

In one embodiment, the current queue length may be retrieved from the queue descriptor entry associated with the flow (e.g., the Qcnt value). As discussed above, the queue descriptor entry for the flow may be located via the buffer pointer.

Next, in a block 808, a new queue state is calculated. In a block 810, a new avg_len value is calculated for each color (as applicable) using Equation 1 above. In general, the appropriate weight value may be retrieved from the WRED data structure, or may be located elsewhere. For example, in some implementations, a single or set of weight values may be employed for respective colors across all service classes.

In conjunction with this calculation, a new timestamp value is also determined. In one embodiment, the respective timestamp values are retrieved during an ongoing cycle to determine if the associated flow queue state is to be updated, thus effecting a sampling period. Based on the difference between the current time and the timestamp, the process can determine whether a given flow queue needs to be processed. Under other embodiments, various types of timing schemes may be employed, such as using clock circuits, timers, counters, etc. As an option to storing the timestamp information in the dynamic portion of a WRED data structure, the timestamp information may be stored as part of the state field or another filed in a flow table entry or otherwise located via a pointer in the entry.

In a block 812, a recalculation of the estimated_drop_probability for each color (as applicable) is performed based on the corresponding WRED drop profile data and updated avg_len value using algorithm 2 shown above. The updated queue state data is then stored in a block 814 to complete the processing for a given flow.

In some implementations, the sampling period for the entire set of active flows will be relatively large when compared with the processing latency for a given packet. Since the sampling interval is relatively large, the recalculation of the queue state may be performed using a processing element that isn't in the fast path. For example, the Intel IXP2XXX NPUs include a general purpose “XScale” processor (depicted as GP Proc 652 in FIG. 6), which is typically used for various operations, including control plane operations (also referred to a slow path operations). Accordingly, an XScale processor or the like may be employed to perform the queue state recalculation operations in an asynchronous and parallel manner, without affecting the fast path operations performed via the microengine threads.

However, for a system with a large number of flows, this approach may require too many computations on the XScale. In addition, the XScale and the microengines need to share the estimated_drop_probability value for a queue via SRAM (since the value is also being read by the microengines). As a result, the slow path operations performed by the Xscale and the fast path operations performed by the microengines are not entirely decoupled.

Since the foregoing scheme only requires four instructions per packet, another implementation possibility is to add the WRED functionality to either scheduler 614 or queue manager 610. Typically, in any application, either the scheduler or the queue manager tracks the instantaneous size of a queue. Since the WRED averaging function requires the instantaneous size, it is appropriate to add this functionality to one of these blocks. The estimated_drop_probability value can be stored in the queue state information used at enqueue time of the packet. The rest of the WRED context can be stored separately in SRAM and accessed only in the sampling path in the manner described above.

In one embodiment, the queue state update is performed by a single thread once every N packets where N is calculated as

$$N = \frac{packet\_arrival \_rate}{number\_of \_queues * queue\_sampling \_rate} \qquad ( 3 )$$

For example, for an OC-192 POS interface with 128 queues, assuming the per-queue sampling rate is 100 times a second, the average queue length calculation needs to be invoked once every (24.5/(128*100)=1914) packets. Note that this design only makes sense if N is substantially greater than one. If the number of queues times the sampling frequency starts to approach the packet arrival rate, then the application may as well compute the queue size on every packet.

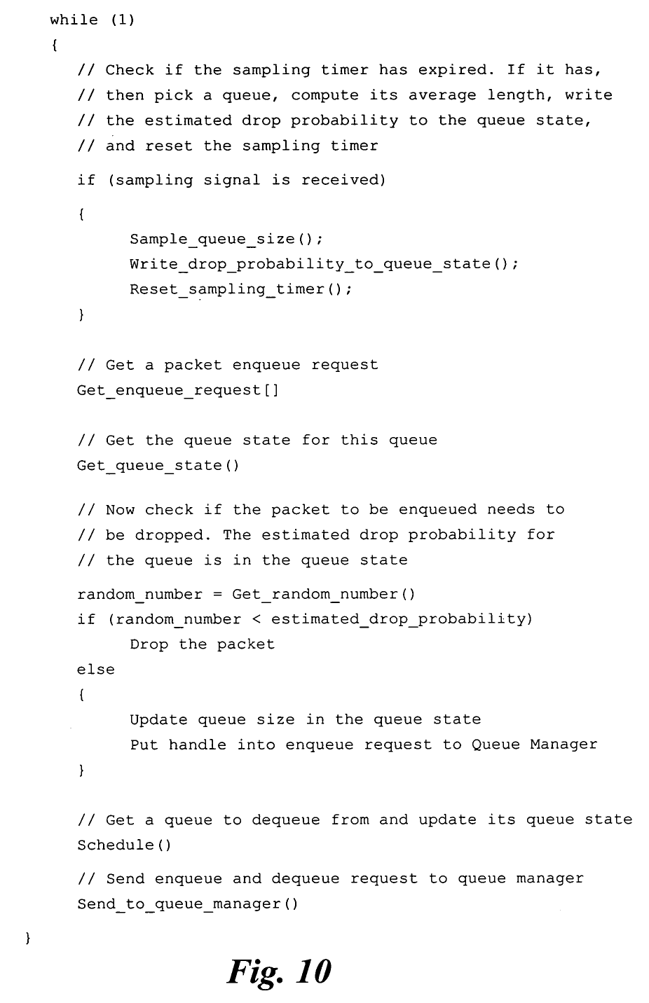

To implement the periodic sampling, the future_count signal in the microengine can be set. The microengine hardware sends a signal to the calling thread after a configurable number of cycles. In the packet processing fast path, a single br_signal [ ] instruction is sufficient to check if the sampling timer has expired. The pseudo-code shown in FIG. 10 illustrates adding WRED to a scheduler that tracks queue size, and handles enqueue and dequeue operations in conjunction with a queue manager.

As discussed above, various operations illustrated by functional blocks and modules in the figures herein may be implemented via execution of corresponding instruction threads on one or more processing elements, such as compute engines (e.g., microengines) and general-purpose processors. Thus, embodiments of this invention may be implemented via execution of instructions upon some form of processing core, wherein the instructions are provided via a machine-readable medium. A machine-readable medium includes any mechanism for storing or transmitting information in a form readable by a machine (e.g., a computer), and may comprise, for example, a read only memory (ROM); a random access memory (RAM); a magnetic disk storage media; an optical storage media; and a flash memory device, etc. In addition, a machine-readable medium can include propagated signals such as electrical, optical, acoustical or other form of propagated signals (e.g., carrier waves, infrared signals, digital signals, etc.).

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the drawings. Rather, the scope of the invention is to be determined entirely by the following claims, which are to be construed in accordance with established doctrines of claim interpretation.

What is claimed is:

1. A method, comprising:
associating a plurality of flows with corresponding Weighted Random Early Detection (WRED) drop profile parameters;
allocating flow queues for the plurality of flows;
repeatedly generating estimated drop probability values for the flow queues based on the WRED drop profile parameters and a flow queue state associated with a given flow queue; and
in response to receiving an input packet,
classifying the packet to a flow;
generating a random number;
retrieving the estimated drop probability value corresponding to the flow queue; and
determining whether to drop the packet based on a comparison of the estimated drop probability value and the random number that is generated.

2. The method of claim 1, further comprising:
defining sets of WRED drop profile parameters;
storing the WRED drop profile parameters in corresponding WRED data structures in memory on the network device; and
accessing the WRED drop profile parameters from the WRED data structures to generate estimated drop probability values.

3. The method of claim 1, further comprising:
executing instructions in a slow path to repeatedly generate estimated drop probability values; and
performing the operations of classifying the packet, generating the random number, and determining whether to drop the packet via execution of instructions in a fast path.

4. The method of claim 1, wherein the method is implemented via execution of instructions on a network processor unit including a general-purpose processor and a plurality of compute engines, the method further comprising:
executing a first set of instructions in the slow path on the general-purpose processor; and
executing additional sets of instructions on at least a portion of the plurality of compute engines to perform the operations of classifying the packet, generating the random number, and determining whether to drop the packet.

5. The method of claim 1, further comprising:
executing a first thread of instructions on a first of a plurality of compute engines on a network processor unit (NPU) to repeatedly generate estimated drop probability values; and
executing at least one thread of instructions on at least one other of the plurality of compute engines to perform the operations of classifying the packet, generating the random number, and determining whether to drop the packet.

6. The method of claim 1, wherein the method is implemented via execution of instructions on a network processor unit including at least one built-in random number generator, the method further comprising generating random numbers using the at least one built-in random number generator.

7. The method of claim 1, wherein the WRED drop profile parameters for at least one flow include separate drop profiles associated with respective Green, Yellow, and Red colors, the method further comprising:
repeatedly generating estimated drop probability values for each of the Green, Yellow, and Red colors for each of the at least one flow; and
in response to receiving an input packet,
classifying the packet to assign the packet to a flow and a color;
generating a random number;
retrieving the estimated drop probability value corresponding to the flow and the color; and
determining whether to drop the packet based on a comparison of the estimated drop probability value and the random number that is generated.

8. The method of claim 1, wherein the estimated drop probability value for a given flow is generated by performing operations comprising:
retrieving the WRED drop profile parameters associated with the flow;
retrieving queue state data for the flow queue;
retrieving a current length of the flow queue;
calculating, using the current length of the flow queue, an updated average length of the flow queue; and
calculating an estimated drop probability value based on the updated average length of the flow queue and the WRED drop profile parameters.

9. The method of claim 8, wherein the updated average length of the flow queue is calculated using a low-pass EWMA (Exponential Weighted Moving Average) filter.

10. The method of claim 1, wherein the periodic generation of an estimated drop probability value for a given flow queue is performed in response to expiration of a sampling timing period.

11. A machine-readable medium to store instructions to be executed on a network device to perform operations comprising:
repeatedly generating estimated drop probability values for each of a plurality of flow queues based on Weighted Random Early Detection (WRED) drop profile parameters and a flow queue state associated with a given flow queue; and
in response to receiving a request to enqueue a packet in a flow queue,
generating a random number;
retrieving the estimated drop probability value corresponding to the flow queue; and
determining whether to drop the packet based on a comparison of the estimated drop probability value and the random number that is generated.

12. The machine-readable medium of claim 11, wherein the instructions include:
a first set of instructions to be executed in a slow path of the network device to repeatedly generate estimated drop probability values; and
a second set of instructions comprising at least one thread to be executed in a forwarding path of the network device to generate the random number and determining whether to drop the packet.

13. The machine-readable medium of claim 11, wherein the instructions are to be executed on at least one compute engine in a network processing unit (NPU) in the network device, and where the instructions include:
a first instruction thread to be executed on a first compute engine to repeatedly generate estimated drop probability values; and
at least one additional instruction thread to be executed on a second compute engine to generate the random number and determining whether to drop the packet.

14. The machine-readable medium of claim 11, wherein the WRED drop profile parameters for at least one flow include separate drop profiles associated with respective Green, Yellow, and Red colors, and execution of the instructions performs further operations comprising:
repeatedly generating estimated drop probability values for each of the Green, Yellow, and Red colors for each of the at least one flow; and
in response to receiving a request to enqueue a packet in a flow queue associated with a flow,
generating a random number;
retrieving the estimated drop probability value corresponding to the flow and a color to which the packet is assigned; and
determining whether to drop the packet based on a comparison of the estimated drop probability value and the random number that is generated.

15. The machine-readable medium of claim 11, wherein the estimated drop probability value for a given flow is generated by execution of the instructions to perform operations comprising:
retrieving WRED drop profile parameters associated with the flow;
retrieving queue state data for the flow queue associated with the flow;
retrieving a current length of the flow queue;
calculating, using the current length of the flow queue, an updated average length of the flow queue; and
calculating an estimated drop probability value based on the updated average length of the flow queue and the WRED drop profile parameters.

16. A network line card, comprising:
a network processor unit (NPU) including,
an interconnect;
a plurality of compute engines coupled to the interconnect, at least one compute engine including a random number generator, each compute engine including a code store;
a Static Random Access Memory (SRAM) interface, coupled to the interconnect;
a Dynamic Random Access Memory (DRAM) interface, coupled to the interconnect;
a general-purpose processor, coupled to the interconnect;
an SRAM store, coupled to the SRAM interface;
a DRAM store, coupled to the DRAM interface; and
a storage device in which instructions are stored to be executed on at least one of the plurality of compute engines and the general-purpose processor of the NPU to perform operations comprising,
repeatedly generating estimated drop probability values for each of a plurality of flow queues based on Weighted Random Early Detection (WRED) drop profile parameters and a flow queue state associated with a given flow queue; and
in response to receiving a request to enqueue a packet in a flow queue,
issuing a request to a random number generator to generate a random number, the random number generator returning a random number;
retrieving the estimated drop probability value corresponding to the flow queue; and
determining whether to drop the packet based on a comparison of the estimated drop probability value and the random number that is generated.

17. The network line card of claim 16, wherein execution of the instructions performs further operations comprising:
loading sets of WRED drop profile parameters in corresponding WRED data structures in the SRAM store; and
reading the WRED drop profile parameters from the WRED data structures to generate estimated drop probability values.

18. The network line card of claim 16, wherein the plurality of instructions include respective sets of instructions comprising instruction threads to be executed on the plurality of compute engine to effect corresponding functional blocks, including:
a queue manager, to manage flow queues stored in the DRAM store;
a scheduler, to schedule transmission of packets stored in flow queues,
wherein at least one instruction thread corresponding to one of the queue manager or scheduler is executed to repeatedly generate estimated drop probability values.

19. The network line card of claim 16, wherein the instructions include:
a first set of instructions to be executed on the general-purpose processor of the network device to repeatedly generate estimated drop probability values; and
a second set of instructions comprising at least one thread to be executed on at least one compute engine to issue the request to generate the random number and determine whether to drop the packet.

20. The network line card of claim 16, wherein execution of the instructions generates estimated drop probability values by performing further operations comprising:
identifying a flow assigned to a packet;
reading the WRED drop profile parameters associated with the flow from a corresponding WRED data structure stored in the SRAM store;
reading queue state data for a flow queue associated with the flow from the SRAM store;
reading data identifying a current length of the flow queue from a queue descriptor array;
calculating, using the current length of the flow queue, an updated average length of the flow queue; and
calculating an estimated drop probability value based on the updated average length of the flow queue and the WRED drop profile parameters.
